(19) United States
(12) Patent Application Publication
(10) Pub. No.: US 2005/0243539 A1
(43) Pub. Date: Nov. 3, 2005

(54) Cooled light emitting apparatus

(76) Inventors: Gareth Peter Evans, West Glamorgan (GB); Kenneth Board, West Glamorgan (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/509,217

(22) PCT Filed: Mar. 25, 2003
(86) PCT No.: PCT/GB03/01271

§ 371 Date: Jun. 6, 2005

(30) Foreign Application Priority Data
Mar. 26, 2002 (GB) 02071769
Jan. 24, 2003 (GB) 03017373

(51) Int. Cl. F21V 9/16

(52) U.S. Cl. 362/84

(57) ABSTRACT

A cooled light emitting apparatus 1 comprises a light source including a close packed array 2 of light emitting diode device (high intensity LEDs) and a cooling system for cooling the light source. The cooling system comprises a thermoelectric cooling device in the form of a Peltier device 4 connected via a heat spreader 3 to the light source and a heat exchange system 5, 6 for removing heat from the Peltier device 4. The heat exchange system 5,6 uses liquid coolant (or refrigerant) to cool the Peltier device 4. By extracting heat from the LED array 2 at a rate greater than 5 W cm⁻² it is possible to maintain the LED array at a temperature of less than −10 degrees Celsius, and thus emit light having an optical power density of greater than 1 Wcm⁻².

The present invention relates to a light emitting apparatus including a light source having one or more light emitting diodes (LEDs) and to a method of cooling such a light source.

In order to maintain efficient light output from light emitting apparatus including LEDs, especially a light emitting apparatus including high brightness LED arrays, and/or to increase the lifetime under operating conditions it is beneficial for the light emitting apparatus to be provided with an effective heat removal system. An improved light emitting apparatus having a highly efficient cooling system has been devised.

According to a first aspect of the present invention, there is provided a light emitting apparatus comprising:

a) a light source including a light emitting diode device; and

b) a cooling system for cooling the light source comprising:

i) a thermoelectric cooling device connected via a heat conductor to the light source; and

ii) a heat exchange system for removing heat from the thermoelectric cooling device. Advantageously, the thermoelectric cooling device is positioned between the heat conductor and the heat exchange system.

The present invention makes it possible to operate the light source at higher powers than would otherwise be possible, thereby facilitating higher optical power densities. The cooling system of the present invention is therefore of particular application in relation to the operation and cooling of high brightness LEDs. The invention may of course have application in relation to other light emitting diode devices such as laser diodes for example. By means of the present invention it is possible to provide an LED array, incorporating high brightness LEDs, that is able to produce light having an optical power density of significantly greater than 0.1 Wcm⁻² (for example, greater than 1 Wcm⁻² or even of the order of or greater than 20 Wcm⁻²). At such optical power outputs the apparatus of the present invention is advantageously so arranged that the temperature of the region of the heat conductor immediately adjacent to the thermoelectric cooling device is able to be maintained below 0 degrees Celsius and preferably below −10 degrees Celsius.

Preferably, the apparatus is arranged to emit, in use, light having an optical power density of greater than 0.1 Wcm^{31 2}.

The light source is preferably arranged and configured to emit light comprising a significant component having a wavelength of between 300 to 1000 m, and preferably light having peak energy output at a wavelength in that range. The range may be between 570 and 600 nm.

According to a second aspect of the invention the heat conductor is in the form of a conductive zone and the heat exchange system is in the form of, or comprises, a heat pipe arrangement. According to this second aspect of the invention there is provided a light emitting apparatus comprising:

a) a light source arrangement; and

b) a cooling system comprising:

i) a heat conductive zone in heat transfer relationship with the light source arrangement;

ii) a thermoelectric cooling device in heat transfer relationship with the heat conductive zone; and

iii) a heat pipe arrangement in heat transfer relationship with the thermoelectric cooling device. In this aspect of the invention it is preferred that the light source arrangement comprises a semi-conductor light source and/or a laser light source.

The first and second aspects of the invention are closely related. Features of the first aspect may readily be incorporated into the second aspect and vice versa. For example, the light source arrangement of the second aspect of the invention may comprise a light emitting diode device. The heat conductive zone of the second aspect may be in the form of a heat conductor. The heat conductor of the first aspect may for example comprise such a heat conductive zone. The heat exchange system of the first aspect may comprise or consist of a heat pipe arrangement in accordance with the second aspect. The heat pipe arrangement of the second aspect may comprise, consist of or be connected to a heat exchange system in accordance with the first aspect.

Optional and preferred features relating to either or both of the first and second aspects of the invention will now be described.

Preferably, the thermoelectric cooling device comprises a Peltier cooling device. The Peltier cooling device is preferably so arranged that it has a proximal end contiguous with the distal end of the heat conductor (or alternatively of the heat conductive zone). The Peltier cooling device is preferably so arranged that it has a distal end contiguous with a proximal end of the heat exchange system (or alternatively of the heat pipe arrangement). The thermoelectric cooling device may comprise a plurality of Peltier cooling devices.

Preferably, the heat exchange system utilises liquid coolant. The liquid coolant may simply comprise water. The liquid coolant may be chosen in dependence on the operating temperature range chosen for the light source and hence the “hot-end” of the thermoelectric cooling device. The coolant may comprise or consist of ethylene glycol. The coolant may have a freezing point (at atmospheric pressure) lower than −10 degrees Celsius and/or may have a boiling temperature (at atmospheric pressure) lower than 25 degrees Celsius. The liquid coolant may be a refrigerant. The heat exchange system is conveniently in the form of a pumped coolant system and preferably comprises a pump for that purpose. Preferably the heat exchange system is itself connected to a heat removal unit for removing heat from the heat exchange system, for example by removing heat from a liquid coolant. The heat removal unit may simply be in the form of a radiator, for example a finned radiator that is cooled by the ambient air. Preferably, the radiator of the heat removal unit is arranged to be cooled by means of the use of forced air convection, for example from a fan system.

The liquid coolant system may include an expansion valve that causes the liquid coolant to evaporate. For example, the liquid coolant system may include a compressor and an expansion valve that causes the liquid coolant to expand and/or evaporate thus cooling the liquid like a refrigerator system.

Conveniently, the heat pipe arrangement of the second aspect of the invention is arranged such that one end of a heat pipe is in heat transfer relationship with the thermoelectric cooling device and the other end is in heat transfer relationship with a heat exchange system.

The heat exchange system (or heat pipe cooling arrangement) beneficially includes a proximal portion contiguous with the thermoelectric cooling device and a distal portion provided with, or connected to, a condenser arrangement which may for example be arranged to condense the vapour used to transport the heat along the heat pipe. The heat exchange system (or heat pipe cooling arrangement) typically carries a coolant fluid, preferably a liquid, to be heated by heat passing out of the thermoelectric cooling device. The coolant is beneficially directed (when heated) in a direction away from the thermoelectric device. The coolant is beneficially arranged to be directed away from the thermoelectric device by means of capillary action and/or diffusion, for example in the case where the cooling system includes a heat pipe. Advantageously, the coolant is pumped, for example in the case where there is a heat exchanger. The coolant is advantageously directed toward a cooling zone, which may be in the distal region of the heat exchange system (or heat pipe cooling arrangement). The coolant is advantageously returned in the direction of the thermoelectric device following cooling at the cooling zone (for example by means of the condenser where present). Beneficially the coolant is arranged to vaporise under transfer of heat from the thermoelectric cooling device.

The heat exchange system (or heat pipe cooling arrangement) preferably includes a proximal zone contiguous with the thermoelectric cooling device and a distal cooling zone. The apparatus beneficially further includes forced cooling means for cooling the heat exchange system (or heat pipe cooling arrangement) in the region of the distal cooling zone. The forced cooling means may comprise water cooling means (for example a water jacket) and/or air cooling means such as an air fan or the like. It will be understood that the heat pipe cooling arrangement of the second aspect of the present invention comprises at least one heat pipe. The heat pipe is advantageously arranged to transport heat away from the “hot zone” of the thermoelectric cooling device with a very small resistance. It will be understood that the heat energy so transported will need to be removed from the heat pipe. The heat pipe arrangement of the second aspect of the invention may be used with forced air cooling only. The heat exchange system of the first aspect does not necessarily need to include a heat pipe.

Providing an apparatus able to emit high intensity light at such wavelengths (made possible by the cooling of the apparatus) may be of particular benefit in relation to uses in, for example, the medical field (for example in relation to the treatment of skin conditions). The apparatus may be arranged to be suitable for use in the medical field.

Advantageously, the light source comprises a plurality of light emitting diode devices. The light emitting diode devices are advantageously arranged in an array. The or each light emitting diode device is advantageously in the form of a solid state device. The array is preferably a two-dimensional array of light emitting diode devices.

The light emitting diodes in the array are preferably arranged so that they are closely packed together. For example, at least two of the light emitting diodes in the array may be packaged and arranged so that the separation between the centres of the light emitting diodes is less than the diameter of the notional circular cylinder that envelopes the packaging (for example, the commercial packaging) of the light emitting diodes. The packaging of the light emitting diode devices may thus be shaped so that the respective light emitting parts of the devices are positioned closer together than would be possible with the use of conventionally shaped packaged LEDs (which commonly have a generally cylindrical shape having a generally circular cross-sectional shape).

The array of light emitting diode devices may for example comprise four such devices arranged so that when viewed from above their centres form the four points of a notional rectangle (for example a square). The faces of the packaging of adjacent light emitting diode devices preferably abut each other, there being contact between the two packages across a significant area. Preferably, the packaging of at least two light emitting diode devices of the light source are substantially flat in part to allow the flat faces to face each other in the assembled light source. The or each light emitting diode device could for example have a cross-sectional shape that is generally hexagonal.

It will be understood that the package or packaging of the light emitting diode device may be in the form of a cover that is substantially transparent to a wavelength of radiation emitted by the light emitting diode device and substantially encapsulates the light emitting part of the light emitting diode device.

The apparatus may be arranged so that at least two of the light emitting diode devices in the array share the same packaging. Alternatively or additionally, the or each light emitting diode device could comprise a plurality of light emitting parts contained within the device (for example contained within the packaging of the device). The light emitting part of the device may for example be in the form of a semi-conductor chip. The light source may for example comprise an array of a multiplicity of discrete light emitting parts closely packed within a given area, the array being contained within a single package. Said given area may be less than 1000 mm² and may even be less than 100 mm². There may be more than 10 light emitting parts within said area. There may be more than 30 light emitting parts within said area. For example, the array may comprise a 10 by 10 square grid of 100 light emitting parts each measuring about 350 μm by 350 μm, the array being contained within a square area measuring 5 mm by 5 mm.

The heat conductor between the thermoelectric cooling device and the light source may comprise a heat spreader. The heat spreader advantageously conducts heat away from a relatively small area to a relatively large area. The heat spreader may be made from or comprise copper metal. The heat spreader is preferably so configured and arranged that it does not impart a large thermal resistance to the path of heat transfer away from the light source. The heat spreader preferably has a shape, and in particular a thickness, that is sufficient to enable the heat confinement to be transformed from a relatively small area to a larger area, thus reducing the heat density.

The apparatus may include a further heat conductor that is arranged to transfer heat from the thermoelectric cooling device to the heat exchange system.

The cooling system may comprise one or more heat pipes for conducting heat to or from a part of the cooling system. Said part of cooling system may be the further heat conductor, so that for example, in use heat is transferred from the thermoelectric cooling device to the heat exchange system via one or more heat pipes. Said part of cooling system may be the heat conductor between the thermoelectric cooling device and the light source. For example, the apparatus may be arranged so that in use heat is transferred from the light source to the thermoelectric cooling device via one or more heat pipes. Heat pipe arrangements known in the art may be sufficient for use in accordance with the apparatus of the invention.

The heat conductor beneficially comprises a layer of high thermal conductivity material arranged contiguously with the light source arrangement. The heat conductive zone of the second aspect of the invention may be in the form of such a layer of high thermal conductivity material. The layer of high thermal conductivity material may comprise a CVD (chemical vapour deposition) diamond coating. The layer of high thermal conductivity material may for example be provided on a substrate, for example, a metal substrate. The substrate may act as, or form, a heat spreader. The substrate and layer of high thermal conductivity material may together form the heat conductor. The thickness of the heat conductive zone may be chosen in dependence on the amount of heat to be removed and the thermal conductivity of the material in the zone. The heat conductor may have a thickness of the order of 1 mm up to about 50 mm. The heat conductor may comprise a heat conductive zone that has a thickness of the order of 1 mm. Beneficially, however, the heat conductive zone is 50 μm or less in thickness (more beneficially 20 μm or less in thickness, most beneficially 10 μm or less in thickness). Such thin layers may for example be provided in the case where the heat conductive zone of the second aspect of the invention is in the form of a layer of high thermal conductivity material. Thus, the heat conductive zone may have a thickness ranging from about 10 μm up to about 5 mm.

The heat conductive zone of the heat conductor is beneficially a layer of deposited high thermal conductivity material, preferably deposited by plasma/chemical vapour deposition techniques. The high thermal conductivity material is advantageously deposited directly on a surface of the light source arrangement (for example such as a rear heat transmissive surface of LED devices or a heat sink mounting for an array of such devices). Beneficially the high thermal conductivity zone comprises a layer of diamond material. Other suitable materials include zinc oxide and/or sapphire material and/or silver material. Heat flowing from the light source arrangement (typically an array of discrete light sources, such as light emitting diode devices) is spread over a larger area by means of a heat spreader having a relatively high thermal conductivity.

The apparatus beneficially includes control means (typically a control unit, microprocessor, or other appropriate drive circuitry) for controlling the cooling system. The thermoelectric cooling device is beneficially arranged to be controlled to determine the heat transfer out of the heat conductor (or heat conductive zone) and/or into the heat exchange system (or heat pipe arrangement). For example, the thermoelectric/Peltier device may include control means for controlling the current to the thermoelectric device for such purpose. By using the thermoelectric/Peltier device to control the heat transfer away from the heat conductor/heat conductive zone (and therefore away from the light source arrangement), the thermal management of the light source arrangement can be optimised and accurately controlled. The apparatus may be arranged simply to cool the light source continuously. Preferably, however the apparatus is arranged to maintain, within a preset range, the temperature of a part of, or in the region of, the light source. The control means may be arranged to receive an input signal from a temperature sensor, such as for example a sensor comprising a thermocouple device. The temperature sensor is preferably positioned as close to the light source as possible. The control means is preferably arranged to operate at least part of the apparatus in dependence on the input signal from the temperature sensor. For example, the cooling system could be operated in a feedback arrangement so as to control the temperature of the light source. The control means may be arranged to maintain the temperature of the region of the cooling system at the junction between the heat conductor and the thermoelectric cooling device at a temperature of less than 15 degrees Celsius, more preferably at a temperature of less than 0 degrees Celsius. The temperature may be maintained substantially within a range of between −40 and −10 and conveniently substantially within a range of between about −25 and about −10 degrees Celsius. The control means may be arranged such that if the control means detects that the temperature is outside the desired range then the control means takes action that warns that the temperature is outside the desired range. Such action might be to operate a warning alarm, such as a visual or audio alarm, or may simply be to cease, at least temporarily, the operation of the light source. Beneficially, the apparatus includes an elongate housing having a proximal portion emitting light from the light source, and a distal portion proximate the distal portion of the heat exchange system (or heat pipe cooling arrangement). The light source, heat conductor (or heat conductive zone), thermoelectric cooling device and heat exchange system (or heat pipe cooling arrangement), are beneficially arranged in the sequence specified and in-line with one another.

According to a third aspect, the present invention provides a cooling system for a light source of an apparatus according to the first aspect of the invention including any of the features described herein with reference to the first aspect of the invention. The cooling system advantageously comprises:

i) a thermoelectric cooling device connected to a heat conductor, and

ii) a heat exchange system for removing heat from the thermoelectric cooling device, the cooling system being arranged to be connected to a light source via the heat conductor. Advantageously, the thermoelectric cooling device is positioned between the heat conductor and the heat exchange system.

When the cooling system is connected to a light source via the heat conductor, the cooling system is able in use to cool the light source.

According to a fourth-aspect, the present invention provides a cooling system for a light source arrangement according to the second aspect of the invention. The cooling system according to this fourth aspect advantageously comprises:

i) a heat conductive zone in heat transfer relationship with the light source arrangement;

ii) a thermoelectric cooling device in heat transfer relationship with the heat conductive zone; and

iii) a heat pipe arrangement in heat transfer relationship with the thermoelectric cooling device.

According to a fifth aspect of the invention, there is provided a method of cooling a light source comprising the steps of:

a) providing and operating a light source including a light emitting diode device; and

b) cooling the light source by means of performing the following steps:

i) removing heat from the light source with a thermoelectric cooling device, and

ii) removing heat from the thermoelectric cooling device with a heat exchange system. Advantageously, the thermoelectric cooling device is positioned between the heat conductor and the heat exchange system.

The region of the cooling system at the junction between the heat conductor and the thermoelectric cooling device is preferably maintained at a temperature of less than 15 degrees Celsius, more preferably at a temperature of less than 0 degrees Celsius. Advantageously, the temperature is maintained below −10 degrees Celsius. For example the temperature may be maintained substantially within a range of between −40 and −10 and conveniently substantially within a range of between about −25 and about −10 degrees Celsius. Said region of the cooling system at the junction between the heat conductor and the thermoelectric cooling device may be in the form of the “cold end” of the thermoelectric cooling device. The temperature may be maintained within a given range by means of control means, for example a control unit, microprocessor, or other appropriate electronic circuitry.

The method of the present invention is of particular application when the light source is driven to provide relatively high optical power densities. The light source may be operated to produce light having an optical power density of greater than 0.1 Wcm⁻². The light source is preferably operated to produce light having an optical power density of greater than 0.5 Wcm⁻². The optical power density of the light is more preferably greater than 1 Wcm⁻². The optical power density may be greater than 10 Wcm⁻². The method of the present invention is of particular application wherein the light source emits a relatively high intensity light from a relatively small area. The light leaving the apparatus is preferably substantially entirely contained within a beam, which in the immediate vicinity of the device has a cross-sectional area of less than 100 cm², preferably an area less than 4 cm².

Preferably, the or each light emitting diode device of the light source is driven with electrical power of between 10 mW and 50 W, and more preferably of between 100 mW and 30 W. In a case where the light source comprises 100 light emitting diode devices (for example in a 10 by 10 square array), the total driving power could be of the order of 100 watts. The light source may thus be driven with electrical power greater than 100 W depending on the number and power rating of the light emitting diode devices. The electrical power may be substantially continuous over periods of the order of seconds, or may be pulsed.

Preferably the light source is operated to emit light having an energy peak at a wavelength between 570 and 600 nm. The rate of heat extracted from the light source may be greater than 1 W cm⁻². Preferably, the rate of heat extracted from the light source is greater than 5 Wcm⁻². More preferably, the rate of heat extraction is greater than 10 Wcm⁻², and yet more preferably greater than or equal to about 20 Wcm⁻².

According to a sixth aspect of the invention there is provided a method of increasing the optical power density attainable with a light source including performing the method according to the fifth aspect of the invention including any of the features described herein with reference to the fifth aspect of the invention.

It will be appreciated that the various aspects of the present invention described above are closely related and that therefore features described with reference to one aspect of the invention may readily be incorporated into another aspect of the invention. For example, the method of the invention may be performed by means of the use of the apparatus of the invention. Thus, it will be understood that the light source of the fifth and sixth aspects of the invention may comprise a plurality of light emitting diode devices arranged in a close-packed array.

Embodiments of the present invention will now be described, by way of example only, with reference to the following schematic drawings of which:

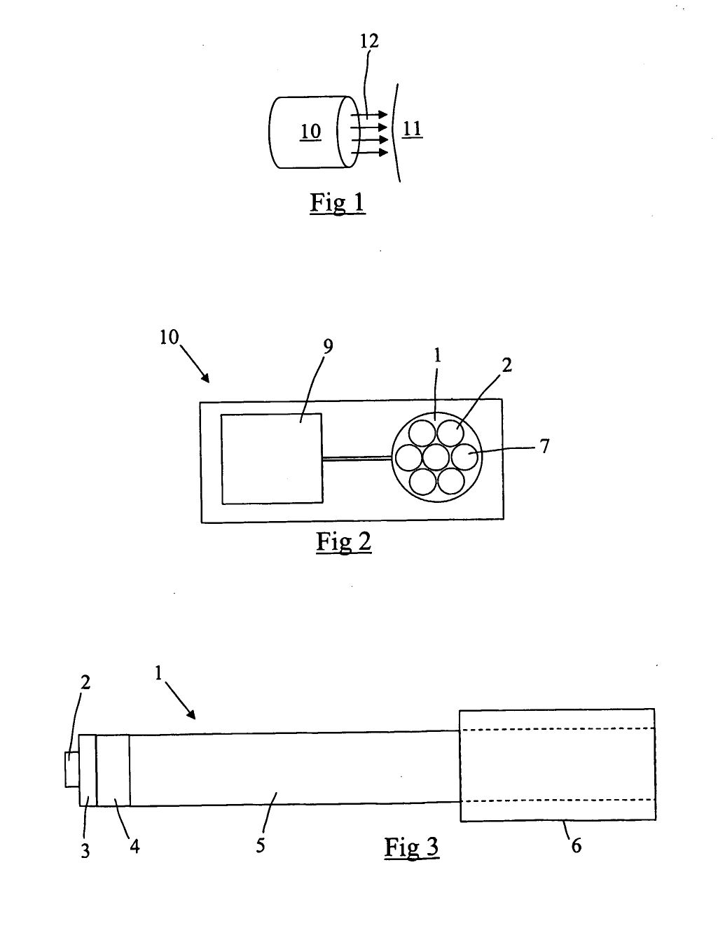

FIG. 1 shows an apparatus according to a first embodiment including a control unit and an illuminating device being used to treat the skin of a patient;

FIG. 2 shows the control unit and illuminating device of the apparatus shown in FIG. 1;

FIG. 3 shows in greater detail the illuminating device of the apparatus shown in FIG. 1;

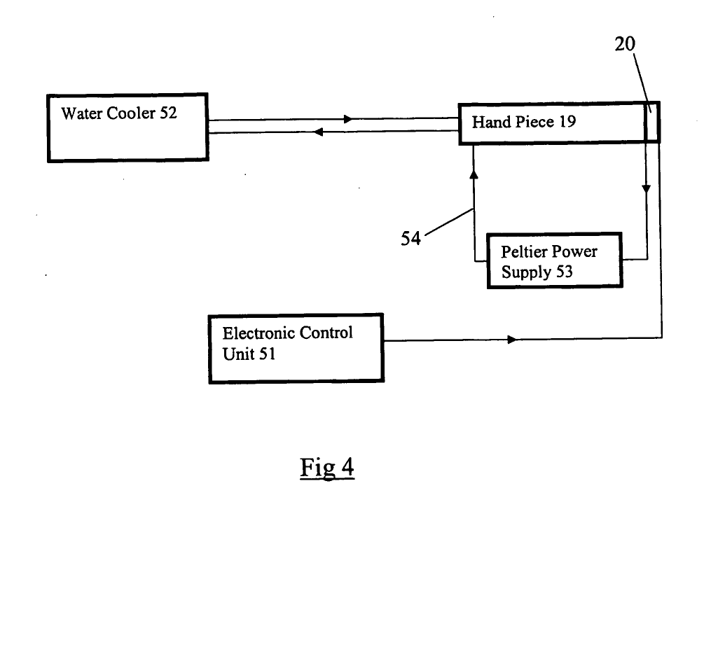

FIG. 4 shows a block diagram illustrating the components of an apparatus according to a second embodiment of the invention;

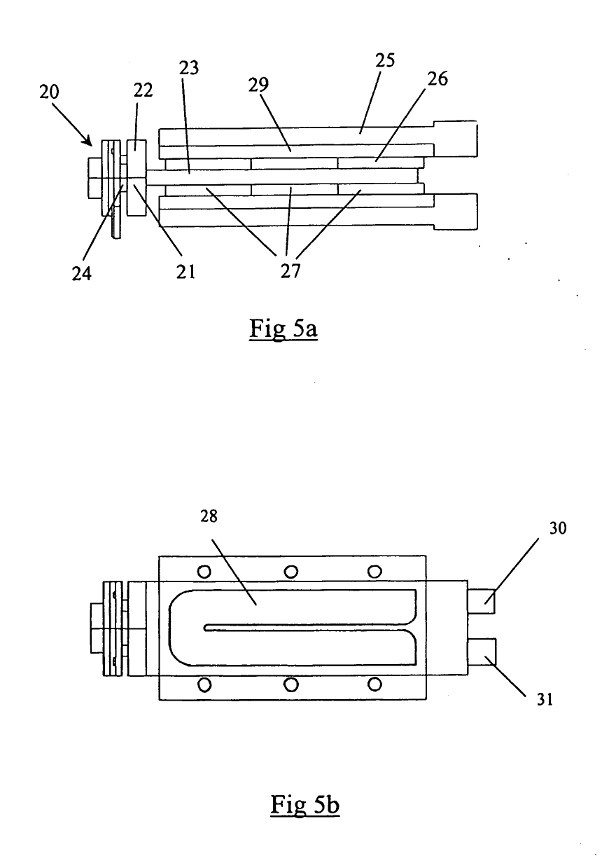

FIG. 5a is a sectional side view of a hand-piece of the apparatus according to the second embodiment;

FIG. 5b is a plan view of the hand-piece shown in FIG. 5a;

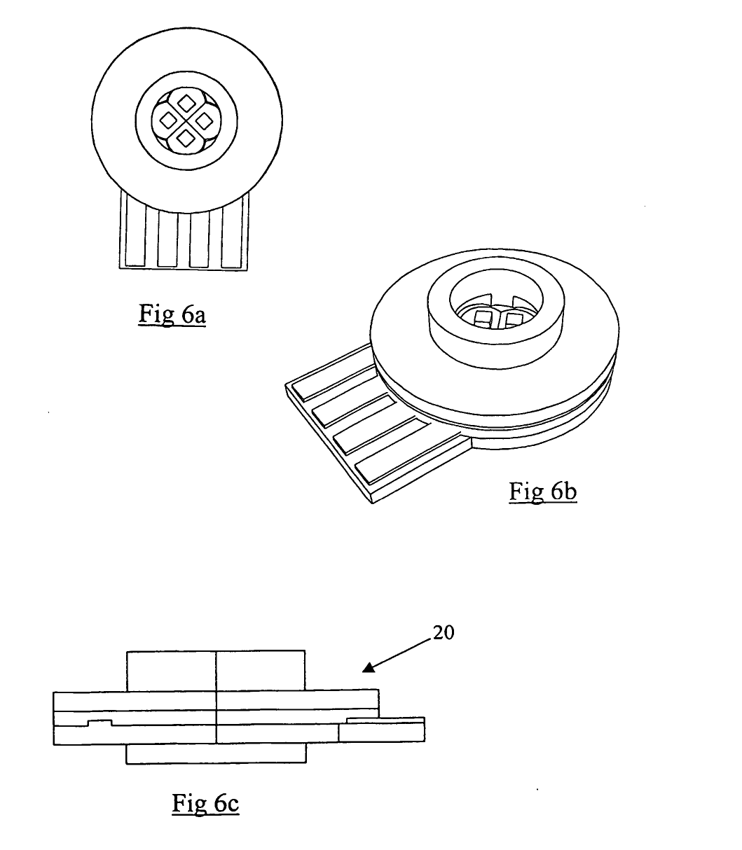

FIG. 6a is an end-on view of the hand-piece of FIG. 5a showing an LED assembly;

FIG. 6b is a perspective view of the LED assembly shown in FIG. 6a; and

FIG. 6c is a side view of the LED assembly shown in FIG. 6a.

FIG. 1 shows the use of an apparatus 10 according to a first embodiment of the present invention. The apparatus is being used to treat a skin condition by directing light radiation 12 onto the skin 11 of a human patient. The light radiation emitted by the apparatus is in the form of a spot having a diameter of about 6 mm. The apparatus 10, in this embodiment a hand-held unit, includes an illuminating device 1 and a control unit 9 linked thereto which controls the radiation emitted by the device 1 and means (not shown in FIG. 1) for cooling the illuminating device. The housing of the apparatus 10 is elongate is shape and has a proximal end via which light is emitted from the illuminating device 1. The overall length of the housing is about 15 cm.

The apparatus is able to be programmed to set the duration of the radiation and the power of radiation. By way of example, the apparatus may be set to provide a single pulse of light energy lasting 1 second that delivers 1.5 Jcm⁻² over the 6 mm diameter circular area. The peak power output of the illuminating device 1 is generally below 5 Wcm⁻². The radiation emitted by the illuminating device includes light having an intensity that peaks at a wavelength of about 585 nm and includes components of light radiation having wavelengths in the range of 570-600 nm. Such wavelengths are suitable for the treatment of certain skin conditions.

The illuminating device includes a plurality of LEDs 7 arranged in a 2-D array 2 (shown schematically in FIG. 2 as LEDs arranged in a close-packed formation) connected to a lens arrangement (not shown) that focuses the radiation emitted by the LEDs, so that a concentrated source of light is provided. The device 1 is therefore suitable for “spot treatment” of skin condition (i.e. treating small areas one at a time). FIG. 3 shows other components of the illuminating device 1, including the cooling means for cooling the LEDs.

Referring to the FIG. 3, there is shown illuminating device (generally designated 1) comprising, in sequence, an LED diode array 2, a high thermal conductivity heat spreader layer 3, a Peltier type thermoelectric cooler 4 and a heat pipe arrangement 5 (including a distal condenser 6).

The heat spreader 3, thermoelectric cooler 4 and heat pipe arrangement 5 are provided to keep the operating temperature of the LEDs at a reduced level and therefore operating most efficiently. It is well-known that the efficiency of an LED increases with reduced operating temperature and in the case of LEDs operating at wavelengths between 550 nm and 650 nm this dependence on temperature is very high.

Heat flowing from the LED diode array 2 is spread over a larger area by the high conductivity spreader layer 3. This layer is typically only a few millimetres thick and provides rapid and highly efficient heat transfer away from the diode array 2. Heat then flows into the cold end of the thermoelectric Peltier cooler 4. The hot end of the thermoelectric Peltier cooler layer 4 is in heat transfer coupling with the heat pipe 5. The LED diode array may be arranged to emit light at any desired wavelength (or wavelength combination or wavelength band or wavelength band combination) and may be operated in pulsed or continuous wave mode. Typically the high thermal conductivity layer 3 includes a diamond material, which is laid down by means of a plasma/chemical vapour deposition method. Other suitable materials include, for example, sapphire materials, zinc oxide materials, silver materials and the like.

The Peltier cooler 4 includes a separate control means including associated drive circuitry which accurately controls, during use, the heat transfer away from the LED diode array 2 via the high thermal conductivity spreader layer 3. Accurate control of the driven Peltier thermoelectric cooler 4 (in combination with the provision of the high thermal conductivity heat spreader layer 3 and the downstream heat pipe cooling arrangement 5) provides for extremely efficient thermal management of the apparatus, and in particular the diode array 2, which ensures consistency of the light output. Also the thermal management of the apparatus may increase the maximum life of the diode array.

The heat pipe arrangement 5 includes a wick to direct fluid coolant (contained in the heat pipe arrangement 5) away from the “hot zone” via capillary action, gravity or diffusion. The arrangement includes a fluid return system to return cooled fluid from the “cold zone” at the distal end of the apparatus, which is provided with a condenser 6. The condenser 6 is itself cooled by air cooling.

This embodiment of the invention provides significant advantages in terms of the synergistic combination of the high thermal conductivity spreader layer 3, the thermoelectric Peltier cooler 4 and the cooling pipe arrangement 5 in enabling closely controlled and efficient thermal management of the LED diode array 2. Typically the arrangement is housed in an elongate housing having a proximal end via which light is emitted from the LED diode array. This arrangement in which the high thermal conductivity heat spreader layer 3, the thermoelectric Peltier cooler device 4 and the heat pipe arrangement 5 are arranged, in sequence, and in-line with one another provides an apparatus/device which is convenient for hand-held manipulation and use particularly when the overall length of the apparatus in the housing is 50 cm or less.

FIGS. 4 to 6c show an apparatus 18 according to a second embodiment of the invention. FIG. 4 shows a block diagram illustrating schematically the parts of the apparatus 18. The apparatus 18 includes a hand-piece 19 in which is housed an LED assembly 20 with an associated integral cooling system (not shown in FIG. 4), a control unit 51 for controlling the hand-piece 19, a power supply 53 for the integral cooling system and a separate water cooling system 52 that removes the heat from the integral cooling system.

The electronic control unit 51 provides the electrical power supply to each LED of the LED assembly in a controlled manner in the form of continuous DC (direct current) power or pulsed power.

The water cooling system 52 comprises a submersible pump, a water reservoir and a radiator system. The radiator system receives heated water from the integral cooling system of the hand-piece 19. That water cools as it passes through the radiator. The cooler water is then fed back to the integral cooling system of the hand piece 19. Heat exchange at the radiator is assisted by means of an air fan.

The power supply 53 for the integral cooling system unit incorporates a feedback loop 54 that assists in the cooling method employed. The temperature of the LED assembly 20 is sensed and the power delivered to the cooling system is controlled to be dependent on the temperature so sensed in order to keep the temperature of the LED assembly at a pre-selected temperature. In this embodiment the pre-selected temperature is −15 degrees Centigrade (258K).

FIG. 5a shows a sectional side view of the hand piece 19 and FIG. 5b shows a plan view of the hand piece 19. As mentioned above, the hand piece comprises an LED assembly 20, which is mounted at one end of the generally elongate hand piece 19, and an integral cooling system, which is housed in the main body of the hand piece. The cooling system comprises a heat spreader 21, a Peltier assembly 26 and a water-cooling unit 25. The overall length of the hand piece is about 15 cm.

The heat spreader 21 consists of a disc 22, one side of which is in thermal conductive contact with a heat sink of the LED assembly 20 and the other side of which is integrally formed with and connected to one end of a flat plate 23. The heat spreader is made from copper (but could be made from or coated with any other material having a high thermal conductivity such as silver or diamond).

The Peltier assembly 26 comprises six Peltier cooling units 27 mounted three on each side of the flat plate 23, so that the cool side of each Peltier unit 27 is in contact with the plate 23 of the heat spreader 21.

The water cooling unit 25, which partially surrounds the Peltier assembly, is in close thermal conductive contact with the hot side of each of the Peltier units 27 and, in use, removes heat from the Peltier assembly 26. The cooling unit 25 comprises two aluminium blocks, positioned on opposite sides of the hand piece 19. FIG. 5b shows one of the blocks in plan view. The block includes a duct 28 sealed by a sealing plates 29 disposed between the duct and the Peltier units 27. Relatively cool water from the separate water cooling system 52 passes into each duct 28 via an inlet port 30 and relatively warmer water is passed out of the duct 28 via an outlet port 31 and flows back to the separate water cooling system 52. The water is circulated by means of the pump of the separate water cooling system 52.

Thus, during use, the LED assembly is cooled by means of the integral cooling system and in particular by the Peltier assembly, and the Peltier assembly is cooled by means of the water cooling unit 25 and the separate water cooling system 52.

The LED assembly is shown in more details in FIGS. 6a to 6c. The LED assembly comprises four standard LEDs, each of which having been modified by shaving or machining away a part of the housing of the LED to form two adjacent perpendicular faces. A shaved face of one LED abuts a shaved face of an adjacent LED, the four LEDs thereby forming an array 41 in the general shape of a cloverleaf. By removing material from the LED housing in this way, the respective dice of the LEDs are brought into closer proximity than would otherwise be possible.

Electrical connections are provided through a printed circuit board 43, which is mounted on the flange defined by the LED assembly 20. On top of the LED array 41 is mounted a reflector 42 comprising a tube 44 of circular cross-section. The light output side of the LED array 41 is surrounded by the tube 44, the interior of which forms a polished reflecting surface 45 which acts to direct the light from the LED array 41 through the circular aperture formed by the open end of the tube 44.

The reflecting surface 45 of the tube is so shaped as to transmit light from the LED array 41 to the circular aperture in as efficient a manner as possible. The wall of the tube 44 is arranged at such an angle that an optimum amount of light is coupled out of the LED array to the circular aperture, whilst minimizing the aperture diameter so as to achieve high optical power densities. The interior of the tube is filled with a soft transparent gel, which prevents condensation on the LED dice. The type of gel used preferably does not discolour with age or temperature cycling is preferably flexible and able to conduct some heat away from the LEDs. The gel, having a refractive index of about 1.5, provides a refractive index step between the semiconductor LED surface layers (refractive index about 3) and the air (refractive index of 1.00). This refractive index step improves the optical extraction by increasing the photon escape probability from within the LED die. Such an optical gel is available from Nye Lubricants of Fairhaven, Mass., USA. (It is believed that Nye Lubricants is a name under which the company known, or formerly known, as William F. Nye, Inc. of New Bedford, Mass., or a related company thereof, trades).

In the region of the free end of the tube, the gel is covered by a layer of hardened transparent epoxy resin that provides optical lensing, physical protection and some refractive index matching between the semiconductor dice and the outside atmosphere. An insulating layer 46 is placed between the printed circuit board 43 and the reflector 45.

The apparatus of the second embodiment has the advantage over the apparatus of the first embodiment that, if desired, the apparatus can be used to produce higher levels of light intensity. This advantage may be enhanced by lowering the operating temperature of the LED array still further, thus increasing the LED efficiency and also allowing the device to be driven to currents higher than that that would be possible at the higher operating temperatures of the LED array. In devices of the prior art, the current flowing through an LED array causes a temperature rise in the LEDs. The maximum temperature at which the LED will work properly depends on the packaging and wiring of the LED die. Thus, if the base temperature of the LED heat sink is lowered then more current may be passed through the LED before the maximum allowable LED temperature is reached. Of course, there may be other limitations, such as maximum permissible current, but such limitations can be overcome with changes to the packaging of the LED array.

It will be appreciated that various modifications may be made to the above-described embodiments of the invention without departing from the spirit of the invention. For example, the illuminating device may be in the form of a line of a plurality of the illuminating devices described above or could be in the form of a 2-D array of illuminating devices.

The spreader of the second embodiment could also be in the form of a shaped heat pipe and could be formed of diamond coated metal. With reference to the second embodiment, rather than modifying the packages of commercially available LEDs by machining their sides, the LED dice could be mounted on a header specifically designed for the purpose. This will allow the LED dice to be packed in much more closely than standard packaged LEDs leading to higher optical output power densities but also requiring higher electrical power densities and thus necessitating the use of an effective cooling arrangement such as that described with reference to the accompanying drawings. Also, the gel inside the reflector tube could be replaced by a number of gels with different refractive indices so as to shape the output light beam in some desired form, for example to produce a narrower beam than would otherwise be the case. The water cooling system of the second embodiment could of course use a liquid coolant other than water. The LEDs described above could be replaced with laser diodes.

1-21. (canceled)

22. Light emitting apparatus comprising:
a) a light source including a light emitting diode device; and
b) a cooling system for cooling the light source comprising:
i) a thermoelectric cooling device connected via a heat conductor to the light source; and
ii) a heat exchange system for removing heat from the thermoelectric cooling device, the thermoelectric cooling device being positioned between the heat conductor and the heat exchange system.

23. Apparatus according to claim 22, wherein the apparatus is so arranged that, in use, the temperature of the region of the heat conductor immediately adjacent to the thermoelectric cooling device is able to be maintained below −10° Celsius.

24. Apparatus according to claim 22, wherein the apparatus is arranged to emit, in use, light having an optical power density of greater than 0.1 Wcm⁻².

25. Apparatus according to claim 22, wherein the light source is arranged and configured to emit light, in use, having an energy peak at a wavelength between 570 nm and 600 nm.

26. Apparatus according to claim 22 wherein the thermoelectric cooling device comprises a Peltier cooling device.

27. Apparatus according to claim 22, wherein the heat exchange system utilizes liquid coolant.

28. Apparatus according to claim 22, wherein the light source comprises a plurality of light emitting diode devices arranged in a two-dimensional array.

29. Apparatus according to claim 28, wherein at least two of the light emitting diodes in the array are packaged and arranged so that the separation between the centers of the light emitting diodes is less than the diameter of the notional circular cylinder that envelopes the packaging of the light emitting diodes.

30. Apparatus according to claim 28, wherein at least two of the light emitting diodes in the array share the same packaging.

31. Apparatus according to claim 22, wherein the heat conductor comprises a heat spreader.

32. Apparatus according to claim 22, wherein a further heat conductor is arranged to transfer heat from the thermoelectric cooling device to the heat exchange system.

33. Apparatus according to claim 22, wherein the cooling system comprises one or more heat pipes for conducting heat to or from a part of the cooling system.

34. Apparatus according to claim 22, wherein the thermoelectric cooling device is arranged to be controlled to determine the heat transfer out of the heat conductor and/or into the heat exchange system.

35. Apparatus according to claim 34, wherein the apparatus includes a control means for controlling the current to the thermoelectric device.

36. A cooling system for a light source arrangement, the cooling system comprising:
i) a thermoelectric cooling device connected to a heat conductor; and
ii) a heat exchange system for removing heat from the thermoelectric cooling device, the cooling system being arranged to be connected to a light source via the heat conductor, the thermoelectric cooling device being positioned between the heat conductor and the heat exchange system.

37. A method of cooling a light source comprising the steps of:
a) providing and operating a light source including a light emitting diode device; and
b) cooling the light source by means of performing the following steps:
i) removing heat from the light source with a thermoelectric cooling device, and
ii) removing heat from the thermoelectric cooling device with a heat exchange system, the thermoelectric cooling device being positioned between the heat conductor and the heat exchange system.

38. A method according to claim 37, wherein the region of the cooling system at the junction between the heat conductor and the thermoelectric cooling device is maintained at a temperature of less than −10° Celsius.

39. A method according to claim 37, wherein the light source is operated to produce light having an optical power density of greater than 0.1 Wcm⁻².

40. A method according to claims 37, wherein the light source is operated to emit light having an energy peak at a wavelength between 570 nm and 600 nm.

41. A method according to claim 37, wherein the rate of heat removed from the light source is greater than 5 Wcm⁻².

42. A method of increasing the optical power density attainable with a light source including performing the method according to any of claim 37.
